(19) United States
(12) Patent Application Publication
(10) Pub. No.: US 2004/0025510 A1
(43) Pub. Date: Feb. 12, 2004

(54) Method for operating a gas and steam turbine installation and corresponding installation

(76) Inventor: Werner Schwarzott, Grossenseebach (DE)

Correspondence Address: HARNESS, DICKEY & PIERCE, P.L.C., P.O.BOX 8910, RESTON, VA, 20195, US

(21) Appl. No.: 10/333,626

(22) PCT Filed: Jul. 12, 2001
(86) PCT No.: PCT/EP01/08079

(51) Int. Cl. F02C 6/18

(52) U.S. Cl. 60/772; 60/39.182

(57) ABSTRACT

In a method operating a gas- and steam-turbine plant (1) having a gas turbine (2) which can be operated with both gas and oil, during a change of operation from gas to oil, a partial-flow mixture (t_{1,2}) formed from a first partial flow (t₁) of heated feedwater (S′) and from a second partial flow (t₂) of comparatively cool feedwater (S) is admixed directly with the cold condensate (K) and thus without a heat exchanger. To this end, the plant (1) comprises a feed line (104) for the heated feedwater (S′), this feed line (104) being directed to the condensate preheater (36) and having an admixing point (103) for feeding the comparatively cool feedwater (S).

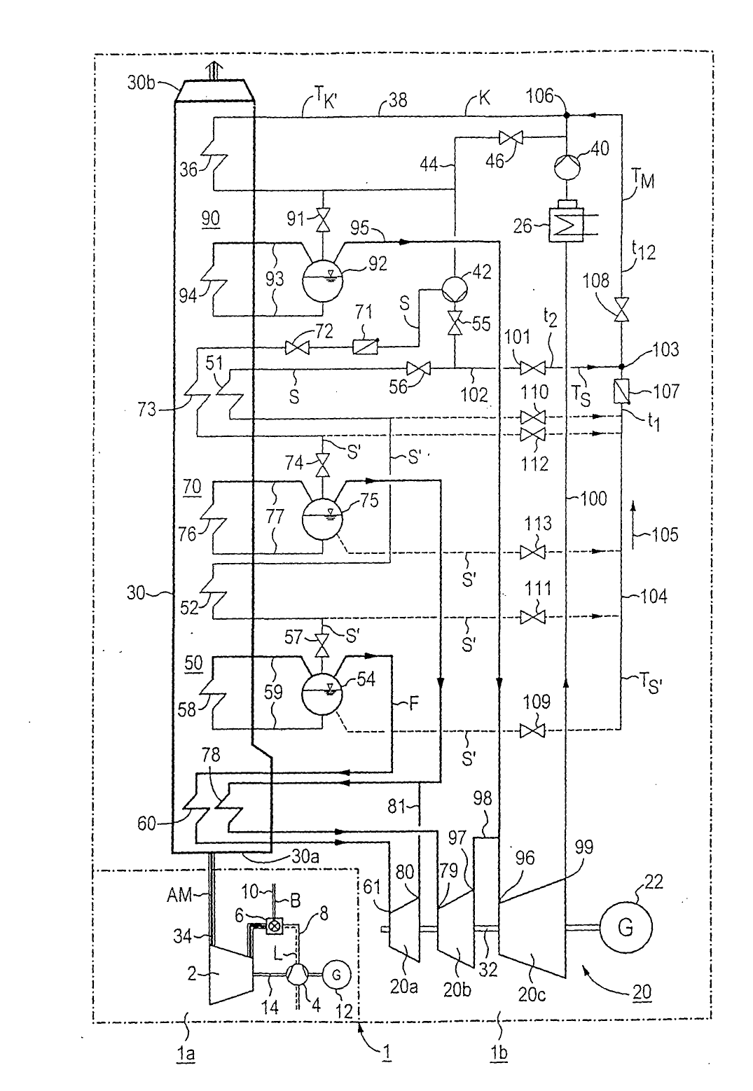

The invention relates to a method of operating a gas- and steam-turbine plant, in which method the flue gas discharging from a gas turbine which can be operated with both gas and oil is directed via a heat-recovery steam generator, the heating surfaces of which are connected in a water/steam circuit of a steam turbine having a number of pressure stages, condensate preheated in the heat-recovery steam generator being heated as feedwater, under high pressure compared with said condensate, and being fed as steam to the steam turbine.

In a gas- and steam-turbine plant, the heat contained in the expanded working medium or flue gas from the gas turbine is utilized for generating steam for the steam turbine connected in a water/steam circuit. In this case, the heat transfer is effected in a heat-recovery steam generator or boiler which is connected downstream of the gas turbine and in which heating surfaces are arranged in the form of tubes or tube bundles. The latter in turn are connected in the water/steam circuit of the steam turbine. The water/steam circuit in this case normally comprises a plurality of pressure stages, for example two or three pressure stages, a preheater and an evaporator and also a superheater being provided as heating surfaces in each pressure stage. EP 0 523 467 B1, for example, discloses such a gas- and steam-turbine plant.

In this case, the total water quantity directed in the water/steam circuit is proportioned in such a way that the flue gas leaving the heat-recovery steam generator, as a result of the heat transfer, is cooled down to a temperature of about 70° C. to 100° C. This means in particular that the heating surfaces exposed to the hot flue gas and pressure drums provided for a water/steam separation are designed for full-load or rated operation, at which a plant efficiency of currently about 55% to 60% is achieved. For thermodynamic reasons, it is also desired in this case that the temperatures of the feedwater, which is directed in the heating surfaces and is under varying pressure, are as close as possible to the temperature profile of the flue gas cooling down along the heat-recovery steam generator as a result of the heat exchange. The aim here is to keep the temperature difference between the feedwater directed via the individual heating surfaces and the flue gas as small as possible in each region of the heat-recovery steam generator. So that as high a proportion as possible of the heat quantity contained in the flue gas is transformed in the process, a condensate preheater for heating condensed water from the steam turbine is additionally provided in the heat-recovery steam generator.

The gas turbine of such a gas- and steam-turbine plant may be designed for operation with various fuels. If the gas turbine is designed for fuel oil and for natural gas, fuel oil, as fuel for the gas turbine, is only provided for a short operating period, for example for 100 to 500 h/a, as “backup” for the natural gas. The priority in this case is normally to design and optimize the gas- and steam-turbine plant for natural-gas operation of the gas turbine. So that a sufficiently high inlet temperature of the condensate flowing into the heat-recovery steam generator is then ensured during fuel-oil operation, in particular during a change from gas operation to oil operation, the necessary heat can be extracted from the heat-recovery steam generator itself in various ways.

One possibility is to bypass the condensate preheater entirely or partly and to heat the condensate in a feedwater tank, connected in the water/steam circuit, by feeding low-pressure steam. However, such a method, at low steam pressures, requires a large-volume and possibly multi-stage heating-steam system in the feedwater tank, a factor which, during long heating intervals, may put at risk deaeration normally taking place in the feedwater tank.

In order in particular to ensure effective deaeration, the condensate temperature in the feedwater tank is normally kept within a temperature range of between 130° C. and 160° C. In this case, preheating of the condensate via a preheater fed with low-pressure steam or hot water from an economizer is provided as a rule, so that the heating interval of the condensate in the feedwater tank is kept as small as possible. In this case, in particular in dual- or triple-pressure plants, hot-water extraction from the high-pressure economizer is necessary in order to provide sufficient heat. However, this has the considerable disadvantage, in particular in triple-pressure plants or circuits, that an external, additional condensate preheater, which has to be designed for the high pressures and high temperatures or high temperature differences, is required. This method is therefore already extremely undesirable on account of the considerable costs and the additional space required for the condensate preheater.

It is also possible, during oil operation of the gas turbine, to carry out or assist the condensate heating in the feedwater tank or in the deaerator with a partial flow from a reheater. However, this method also cannot be used in particular in modern plant circuits without a feedwater tank and without a deaerator, especially as there are no devices or apparatus for mixed preheating.

DE 197 36 889 C1 has certainly disclosed a method which, compared with the methods described, can be carried out with little outlay in terms of apparatus and operation and which is based on a displacement of the exhaust-gas heat in the direction of the condensate preheating as a result of a reduction in the low-pressure range and on an installation of economizer bypasses on the water side. However, there are also limits to the implementation of this method with certain requirements.

The object of the invention is therefore to specify a method of operating a gas- and steam-turbine plant of the aforesaid type, which method, with at the same time little outlay in terms of apparatus and operation, in an effective manner which is favorable with regard to the plant efficiency, ensures a change from gas operation to oil operation of the gas turbine while covering a wide temperature range of the inlet temperature of the condensate flowing into the heat-recovery steam generator. Furthermore, a gas- and steam-turbine plant which is especially suitable for carrying out the method is to be specified.

With regard to the method, the object is achieved according to the invention by the features of claim 1. To this end, provision is made for feedwater which is under high pressure compared with the condensate and has a high temperature compared with the condensate to be expediently admixed with the cold condensate without a heat exchanger and thus directly via an additional pipeline. The heated feedwater or hot water is extracted as a first partial flow from a high-pressure drum in the case of dual-pressure system, i.e. in the case of a dual-pressure plant, and from the high-pressure drum and/or from an intermediate-pressure drum in the case of a triple-pressure system or triple-pressure plant. Alternatively, the first partial flow may also be extracted at the outlet of the high-pressure economizer or the intermediate-pressure economizer.

If and when required, the pressure of the low-pressure system may be additionally increased in order to displace heat contained in the flue gas from the low-pressure system toward the condensate preheater arranged downstream of the latter on the flue-gas side. It is essential in this case that the heated feedwater, which is extracted from the water/steam circuit at a suitable point and is in the form of a partial-flow mixture of feedwater partial flows of different temperature, is admixed with the cold condensate without prior heating, i.e. without heat exchange in an additional heat exchanger.

In this case, the invention is based on the idea that an additional heat exchanger which cools the heated feedwater or heating water, extracted from the water/steam circuit, to the temperature level of the condensate system before its pressure is reduced in order to thereby prevent the generation of steam following the pressure reduction can be dispensed with if a partial flow of feedwater having a likewise high pressure but a comparatively low temperature is admixed with the heated feedwater before its pressure is reduced such that the mixing temperature which occurs is below the boiling temperature in the condensate system.

In this case, in particular in a triple-pressure system, heated feedwater can be extracted from the intermediate-pressure system, from the high-pressure system or from both systems. The extraction here depends essentially on the heat required for heating the condensate and also on which plant efficiency is to be at least maintained during oil operation, serving only as backup, of the gas turbine.

With regard to the plant, the object is achieved according to the invention by the features of claim 6. So that the partial-flow mixture formed from the first partial flow of heated feedwater and from the second partial flow of comparatively cool feedwater is admixed with the cold condensate directly and thus without a heat exchanger during a change of operation from gas to oil, the plant comprises a feed line for the heated feedwater, this feed line being directed to the condensate preheater and having an admixing point for feeding the comparatively cool feedwater.

Advantageous developments are the subject matter of subclaims 7 to 10.

The advantages achieved with the invention consist in particular in the fact that a water inlet temperature which is required during oil operation of the gas turbine and is increased compared with the gas operation of the gas turbine can be set in the heat-recovery steam generator with especially simple means even without an additional heat exchanger or external condensate preheater by heated feedwater which is set to a suitable mixing temperature and is under high pressure being admixed with the cold condensate directly, i.e. without a heat exchanger. In this case, by the provision of a partial-flow mixture from two feedwater partial flows of different temperature, a mixing temperature of the partial-flow mixture admixed directly with the cold condensate during oil operation, which mixing temperature is below the boiling temperature of the preheated condensate or of the condensate to be preheated, can be produced in an especially simple and effective manner. In addition, since the rate of flow in the condensate preheater correspondingly increases via the returned feedwater, condensate circulating pumps hitherto necessary may be dispensed with. In particular, it is possible to cover a wide temperature range of the inlet temperature of the steam generator or boiler without circuit modification.

It can be seen that the capacity reserves of the high-pressure feedwater pump can also be utilized in this way, since during oil operation, compared with gas operation, on account of a lower gas-turbine output, lower delivery quantities are normally also required. Standardization is also possible on account of the operating range expanded in terms of the circuit in an especially effective manner. Furthermore, the investment costs are especially low.

On account of the comparatively less complex controls and changeovers, a comparatively simple mode of operation is achieved on the one hand, and comparatively high reliability is also achieved, since components which are less active overall are required. On account of the comparatively small number of components, the maintenance cost is reduced and fewer spare parts are required to be held in stock.

An exemplary embodiment of the invention is explained in more detail below with reference to a drawing. In the drawing, the FIGURE schematically shows a gas- and steam-turbine plant designed for a change of operation from gas to oil.

The gas- and steam-turbine plant 1 according to the FIGURE comprises a gas-turbine plant 1a and a steam-turbine plant 1b. The gas-turbine plant 1a comprises a gas turbine 2 with coupled air compressor 4 and a combustion chamber 6 which is connected upstream of the gas turbine 2 and is connected to a fresh-air line 8 of the air compressor 4. Opening into the combustion chamber 6 is a fuel line 10, via which gas or oil, as fuel B, can be fed alternatively to the combustion chamber 6. The fuel B is burned with the feeding of compressed air L to form working medium or fuel gas for the gas turbine 2. The gas turbine 2 and the air compressor 4 and also a generator 12 sit on a common turbine shaft 14.

The steam-turbine plant 1b comprises a steam turbine 20 with coupled generator 22 and, in a water/steam circuit 24, a condenser 26 connected downstream of the steam turbine 20 and also a heat-recovery steam generator 30. The steam turbine 20 has a first pressure stage or a high-pressure part 20a and a second pressure stage or an intermediate-pressure part 20b, and also a third pressure stage or a low-pressure part 20c, which drive the generator 22 via a common turbine shaft 32.

To feed working medium or flue gas AM, expanded in the gas turbine 2, into the heat-recovery steam generator 30, an exhaust-gas line 34 is connected to an inlet 30a of the heat-recovery steam generator 30. The flue gas AM from the gas turbine 2, which flue gas AM is cooled down along the heat-recovery steam generator 30 as a result of indirect heat exchange with condensate K and feedwater S directed in the water/steam circuit 24, leaves the heat-recovery steam generator 30 via its outlet 30b in the direction of a stack (not shown).

The heat-recovery steam generator 30 comprises, as heating surfaces, a condensate preheater 36, which is fed with condensate K from the condenser 26 on the inlet side via a condensate line 38 in which a condensate pump 40 is connected. The condensate preheater 36 is directed on the outlet side to the suction side of a feedwater pump 42. To bypass the preheater 36 if and when required, it is bridged with a bypass line 44, in which a valve 46 is connected.

The feedwater pump 42 is designed as a high-pressure feedwater pump with intermediate-pressure extraction. It brings the condensate K to a pressure level of about 120 bar to 150 bar, this pressure level being suitable for a high-pressure stage 50, assigned to the high-pressure part 20a of the steam turbine 20, of the water/steam circuit 24. Via the intermediate-pressure extraction, the condensate K is brought to a pressure level of about 40 bar to 60 bar, this pressure level being suitable for an intermediate-pressure stage 70 assigned to the intermediate-pressure part 20b of the steam turbine 20.

The condensate K which is conducted via the feedwater pump 42 and is designated as feedwater S on the pressure side of the feedwater pump 42 is partly fed at high pressure to a first high-pressure economizer 51 or feedwater preheater and via the latter to a second high-pressure economizer 52. The latter is connected on the outlet side to a high-pressure drum 54 via a valve 57.

In addition, the feedwater S is partly fed at intermediate pressure to a feedwater preheater or intermediate-pressure economizer 73 via a check valve 71 and a valve 72 connected downstream of the latter. The intermediate-pressure economizer 73 is connected on the outlet side to an intermediate-pressure drum 75 via a valve 74. Similarly, as part of a low-pressure stage 90, assigned to the low-pressure part 20c of the steam turbine 20, of the water/steam circuit 24, the condensate preheater 36 is connected on the outlet side to a low-pressure drum 92 via a valve 91. The pressure level in the low-pressure stage 90 is about ??? Bar to ??? Bar.

The intermediate-pressure drum 75 is connected to an intermediate-pressure evaporator 76 arranged in the heat-recovery steam generator 30 for forming a water-steam circulation 77. Arranged on the steam side on the intermediate-pressure drum 75 is a reheater 78, which is directed on the outlet side (hot reheating) to an inlet 79 of the intermediate-pressure part 20b, and into which an exhaust-steam line 81 connected to an outlet 80 of the high-pressure part 20a of the steam turbine 20 is directed on the inlet side (cold reheating).

On the high-pressure side, the feedwater pump 42 is connected to the high-pressure drum 54 via two valves 55, 56 and via the first high-pressure economizer 51 and the second high-pressure economizer 52, connected downstream of the latter on the feedwater side and arranged upstream of the same in the heat-recovery steam generator 30 on the flue-gas side, and also via a further valve 57, provided if and when required. The high-pressure drum 54 is in turn connected to a high-pressure evaporator 58 arranged in the heat-recovery steam generator 30 for forming a water/steam circulation 59. To draw off live steam F, the high-pressure drum 54 is connected to a high-pressure superheater 60 which is arranged in the heat-recovery steam generator 30 and is connected on the outlet side to an inlet 61 of the high-pressure part 20a of the steam turbine 20.

The high-pressure economizers 51, 52 and the high-pressure evaporator 58 and also the high-pressure superheater 59 together with the high-pressure part 20a form the high-pressure stage 50 of the water/steam circuit 24. The intermediate-pressure evaporator 76 and the reheater 78 together with the intermediate-pressure part 20b form the intermediate-pressure stage 70 of the water/steam circuit 24. Similarly, a low-pressure evaporator 94 arranged in the heat-recovery steam generator 30 and connected to the low-pressure drum 94 for forming a water/steam circulation 93 forms, together with the low-pressure part 20c of the steam turbine 20, the low-pressure stage 90 of the water/steam circuit 24. To this end, the low-pressure drum 92 is connected on the steam side to an inlet 96 of the low-pressure part 20c via a steam line 95. An overflow line 98 connected to an outlet 97 of the intermediate-pressure part 20b opens into the steam line 95. An outlet 99 of the low-pressure part 20c is connected to the condenser 26 via a steam line 100.

The gas turbine 2 of the gas- and steam-turbine plant 1 can be operated with both natural gas and fuel oil as fuel B. During gas operation of the gas turbine 2, the working medium or flue gas AM fed to the heat-recovery steam generator 30 has comparatively high purity, the water/steam circuit 24 and the plant components being designed for this operating state and being optimized with regard to its efficiency. A valve 101 which lies in a partial-flow line 102 connected to the pressure side of the feedwater pump 42 via the valve 55 is closed in this operating state.

During the change from gas operation to oil operation of the gas turbine 2, the valve 101 is opened. The partial-flow line 102 is connected to an admixing point 103 of a feed line 104 which is connected on the outflow side in the flow direction 105 to the condensate line 38 via a mixing point 106. In the flow direction 105, a check valve 107 lies in the feed line 104 upstream of the admixing point 103 and a valve 108 lies in the feed line 104 downstream of the admixing point 103.

With the opening, or following the opening, of the valve 101 during oil operation of the gas turbine 2, an adjustable first partial flow t₁ of heated feedwater S′ is directed into the admixing line 104, this feedwater S′ being extracted preferably from the water side of the high-pressure drum 54 via a valve 109. Alternatively, the heated feedwater S′, as adjustable first partial flow t₁, may also be extracted from the outlet side of the first high-pressure economizer 51 via a valve 110 or from the outlet side of the second high-pressure economizer 52 via a valve 111.

Alternatively or additionally, in the triple-pressure system shown, heated feedwater S′, as adjustable first partial flow t₁, may also be extracted from the outlet side of the intermediate-pressure economizer 73 via a valve 112 or from the water side of the intermediate-pressure drum 75 via a valve 113.

A second partial flow t₂ of comparatively cool feedwater S is admixed with the first partial flow t₁ of heated feedwater S′ at the admixing point 103. The second partial flow t₂ directed via the partial-flow line 102 can be adjusted by means of the valve 101. The partial-flow mixture t_{1,2} formed in the process is admixed with the cold condensate K via the mixing point 106. In this case, the temperature T_{S}. of the first partial flow t₁ during its extraction as heated feedwater S′ from the high-pressure drum 54 is, for example, 320° C.

At a temperature T_{S} of the second partial flow t₂ as comparatively cool feedwater S of, for example, 150° C., a mixing temperature T_{M} of the partial-flow mixture t_{1,2} of about 210° C. is obtained by appropriate setting of the quantities of the two partial flows t₁ and t₂ by means of the valves 109 to 112 and 101, respectively. The mixing of the two partial flows t₁ and t₂ of different feedwater temperatures T_{S′} and T_{S}, respectively, ensures that the heated feedwater or heating water S′ extracted from the water/steam circuit 54, before its pressure is reduced when being introduced via the mixing point 106 into the condensate line 38, is cooled to the temperature level of the condensate system and thus to below 200° C. As a result, the generation of steam following the pressure reduction is prevented, the valve 108 serving to reduce the pressure of the partial-flow mixture t_{1,2}.

Due to fact that the partial-flow mixture t_{1,2} formed from the two feedwater partial flows t₁ and t₂ of different temperatures T_{S′}, T_{S} is admixed directly with the cold condensate K, i.e. without a heat exchanger, a water- or boiler-inlet temperature T_{K′} of, for example, 120 to 130° C., which is required during oil operation of the gas turbine 2 and is increased compared with gas operation, can be set with especially simple means and in particular without the interposition of an additional heat exchanger.

1. A method of operating a gas- and steam-turbine plant (1), in which method the flue gas (AM) discharging from a gas turbine (2) which can be operated with both gas and oil is directed via a heat-recovery steam generator (30), the heating surfaces of which are connected in a water/steam circuit (24) of a steam turbine (20) having a number of pressure stages (20a, 20b, 20c), condensate preheated in the heat-recovery steam generator (30) being heated as feedwater (S), under high pressure compared with said condensate, and being fed as steam (F) to the steam turbine (20), wherein, during a change of operation from gas to oil, a partial-flow mixture (t_{1,2}) formed from a first partial flow (t₁) of heated feedwater (S′) and from a second partial flow (t₂) of comparatively cool feedwater (S) is admixed directly with the cold condensate (K).

2. The method as claimed in claim 1, wherein the second partial flow (t₂) admixed with the first partial flow (t₁) before its pressure is reduced to the pressure level of the condensate (K) is adjusted in such a way that the temperature (T_{M}) of the partial-flow mixture (t_{1,2}) is below the boiling temperature of the condensate (K) to be preheated.

3. The method as claimed in claim 1 or 2, wherein the first partial flow (t₁) is extracted from a high-pressure stage (50) and/or an intermediate-pressure stage (70) of the water/steam circuit (24).

4. The method as claimed in one of claims 1 to 3, wherein the first partial flow (t₁) is extracted from the outlet side of a high-pressure economizer (51, 52) or intermediate-pressure economizer (73) provided as heating surface in the heat-recovery steam generator (30).

5. The method as claimed in one of claims 1 to 4, wherein the first partial flow (t₁) is extracted from a high-pressure drum (54) or intermediate-pressure drum (75) connected in the water/steam circuit (24).

6. A gas- and steam-turbine plant (1) having a gas turbine (2) which can be operated with both gas and oil and having a heat-recovery steam generator (30) which is connected downstream of the gas turbine (2) on the exhaust-gas side and the heating surfaces of which are connected in the water/steam circuit (24) of a steam turbine (20) comprising at least one low-pressure stage (20c) and one high-pressure stage (20b), wherein there is provided a feed line (104) which on the outflow side is directed to the inlet side of a condensate preheater (36) arranged as heating surface in the heat-recovery steam generator (30), has an admixing point (103) and on the inflow side is directed to the water side of a pressure drum (54, 75) connected in the water/steam circuit (24) and/or to the outlet side of an economizer (51, 52, 73) arranged as heating surface in the heat-recovery steam generator (30), in which case an adjustable second partial flow (t₂) of comparatively cool feedwater (S) can be fed via the admixing point (103) to a first partial flow (t₁) of heated feedwater (S′), this first partial flow (t₁) being extracted from the pressure drum (54, 75) or from the economizer (51, 52, 73) and being directed via the feed line (104).

7. The gas- and steam-turbine plant as claimed in claim 6, wherein, in the flow direction (105) of the partial-flow mixture (t_{1,2}) formed from the first partial flow (t₁) and from the second partial flow (t₂), a valve (108) for reducing the pressure of the first partial flow (t₁) and/or of the partial-flow mixture (t_{1,2}) is connected in the feed line (104) downstream of the admixing point (103).

8. The gas- and steam-turbine plant as claimed in claim 6 or 7, wherein, to adjust the first partial flow (t₁), at least one valve (109 to 113) is connected in the feed line (104) upstream of the admixing point (103) in the flow direction (105) of the first partial flow (t₁).

9. The gas- and steam-turbine plant as claimed in one of claims 6 to 8, comprising a partial-flow line (102) which on the outlet side opens into the admixing point (103) and on the inlet side is connected to the pressure side of a feedwater pump (42).

10. The gas- and steam-turbine plant as claimed in claim 9, wherein a valve (101) for adjusting the second partial flow (t₂) is connected in the partial-flow line (102).
